(19) United States
(12) Patent Application Publication
(10) Pub. No.: US 2021/0347701 A1
(43) Pub. Date: Nov. 11, 2021

(54) SPHERICAL MICROPARTICLES FORMED USING EMULSIONS AND APPLICATIONS OF SAID MICROPARTICLES

(71) Applicant: Lawrence Livermore National Security, LLC, Livermore, CA (US)

(72) Inventors: James Timothy Cahill, Livermore, CA (US); Wyatt Du Frane, Livermore, CA (US); Joshua D. Kuntz, Livermore, CA (US); Ryan Lu, Daly City, CA (US); Amy Wat, Oakland, CA (US); Marcus A. Worsley, Hayward, CA (US); Congwang Ye, Livermore, CA (US)

(21) Appl. No.: 17/315,058

(22) Filed: May 7, 2021

Related U.S. Application Data
(60) Provisional application No. 63/022,194, filed on May 8, 2020.

(51) Int. Cl. C04B 35/58; C04B 35/626; C04B 35/634; C04B 35/622; B33Y 70/00

(52) U.S. Cl. CPC C04B 35/58078; C04B 35/62695; C04B 35/63448; C04B 35/6269; C04B 35/62222; B33Y 10/00; C04B 2235/3813; C04B 2235/5454; C04B 2235/5436; C04B 2235/528; C04B 2235/6026; B33Y 70/00

(57) ABSTRACT

A composition includes a plurality of microparticles, where the microparticles comprise agglomerates of nanopowder, wherein the nanopowder includes a material selected from the following: a ceramic material, a metal, an alloy, a polymer, or a combination thereof. The microparticles are characterized by having an essentially spherical shape, nanograin features substantially identical to nanograin features of the nanopowder prior to formation into the microparticles, and a nanoscale porosity defined by the nanograin features. The plurality of microparticles have an essentially uniform size relative to one another. Moreover, the composition has flowability having a Hausner Ratio representing tapped density:bulk density less than 1.25.

### RELATED APPLICATIONS

This application claims priority to U.S. Provisional Patent Application No. 63/022,194 filed May 8, 2020 which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to nanopowders and nanomaterials, and more particularly to processes for flowability of spherical microparticles comprising nanopowders, and methods of making and using the same.

### BACKGROUND

Nanopowders and nanomaterials are used in a wide variety of applications as they often portray desirable characteristics compared to their macroparticle counterparts. Ceramic and metal materials are no exception and nanograined structures often display increased strength and other enhanced properties. Unfortunately, nanoparticles present challenges from the standpoint of handling and safety which may prevent their use in an otherwise suitable application. Nanopowders often display poor flowability due to the interparticle forces that dominate at small length scales making them difficult to load into dies, flow through equipment or spread onto surfaces.

Spray drying and spray atomization are two of the most common techniques for producing spherical particles of either ceramics or metals that display uniform particle sizes and good flowability. However, these techniques are limited in the ability to carefully control the density of the particle. In spray drying, the rapid evaporation of the liquid phase causes a collapse of the inter-particle pore structure, resulting in a densely-packed agglomerate of particles. Spray atomization involves heating the compound above its melting temperature to form droplets that cool in a spherical form, effectively removing all porosity and nanograin features.

While densely-packed microparticles might be desirable for some applications, there are many other scenarios where lower density (porous) structures or coatings are desired. Ceramic materials in particular have many applications where higher porosity is critical such as high-temperature insulation, light-weight aerospace structures, high-surface area sensors, catalyst, scaffolds, heat exchangers or fuel cells. However, the poor flowability of nanopowders has prevented use of the nanopowders in a variety of processes, e.g., spray techniques, three-dimensional printing, etc.

What is needed, and absent from the art, is development of a process for enhancing flowability of nanopowders.

### SUMMARY

In one embodiment, a composition includes a plurality of microparticles, where the microparticles comprise agglomerates of nanopowder, wherein the nanopowder includes a material selected from the following: a ceramic material, a metal, an alloy, a polymer, or a combination thereof. The microparticles are characterized by having an essentially spherical shape, nanograin features substantially identical to nanograin features of the nanopowder prior to formation into the microparticles, and a nanoscale porosity defined by the nanograin features. The plurality of microparticles have an essentially uniform size relative to one another. Moreover, the composition has flowability having a Hausner Ratio representing tapped density:bulk density less than 1.25.

According to another embodiment, a method includes creating an emulsion having a plurality of spherical droplets by agitating a mixture comprising a suspension and a carrier fluid, curing the emulsion for causing the plurality of spherical droplets to form a plurality of spherical microparticles, and collecting the plurality of spherical microparticles. The suspension comprises a nanopowder and a solution, and the carrier fluid is immiscible with the suspension.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a representational drawing of a process of forming spherical microparticle agglomerates, according to one embodiment. Part (a) is schematic drawing of an emulsion including spherical droplets, part (b) is an image representative of dried microspheres, and part (c) is a magnified view of a microsphere of part (b).

FIG. 2A is an image of an ultra-fine-grained material that may be included in spherical microparticle agglomerates, according to one approach.

FIG. 2B is an image of spherical particles with sub-micron grains having a uniform size, according to one approach.

FIG. 3 is a flow chart of a method, according to one embodiment.

FIG. 4 is a series of images of forming an emulsion using resonant acoustic mixing, according to one approach.

FIG. 5 is a schematic drawing of forming spherical microparticle having agglomerates of nanoparticles, according to one embodiment. Part (a) represents formulating a suspension, part (b) represents emulsifying the suspension, part (c) represents curing the emulsion, part (d) represents drying and oil removal, and part (e) represents testing for flowability.

FIG. 6 is a series of images of drying cured particles, according to one approach.

FIG. 7A is an optical image of wet spherical microparticle agglomerates formed by resonant acoustic mixing, according to one approach.

FIG. 7B is a scanning electron micrograph (SEM) image of dry spherical microparticle agglomerates formed by resonant acoustic mixing, according to one approach.

FIG. 8 is a schematic representation of forming an emulsion using inline blending, according to one approach.

FIG. 9A is an optical image of wet spherical microparticle agglomerates formed by an immersion blender, according to one approach.

FIG. 9B is a scanning electron micrograph (SEM) image of dry spherical microparticle agglomerates formed by an immersion blender, according to one approach.

FIG. 10 is a schematic drawing of a portion of a thermal barrier coating (TBC) of a turbine blade, in which the TBC coating includes Yttria-stabilized Zirconia.

FIG. 11 is a schematic drawing of a portion of a TBC of a turbine blade, in which the TBC coating includes Zirconium diboride, according to one embodiment.

FIG. 12A is an optical image of cured ceramic spherical microparticle agglomerates in silicone oil, according to one approach.

FIG. 12B is an image of dried spherical microparticle agglomerates, according to one approach.

FIG. 12C is an image of an individual dried microparticle formed from an emulsion comprising nano zirconium diboride (ZrB₂), according to one approach.

FIG. 12D is an image of an individual dried microparticle formed from an emulsion comprising nano boron (B) and nano zirconia (ZrO₂), followed by a reduction step to form zirconium diboride (ZrB₂), according to one approach.

FIG. 13 is a table of factors that affect particle size, according to various approaches.

FIG. 14A is an optical image of spherical microparticle agglomerates suspended in oil for calculating particle size, according to one approach.

FIG. 14B is a plot of the particle size distribution determined from the image of FIG. 14A, according to one approach.

FIG. 15A is a scanning electron micrograph of dried spherical microparticle agglomerates for calculating particle size, according to one approach.

FIG. 15B is a plot of the particle size distribution determined from the image of FIG. 15A, according to one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

It is also noted that, as used in the specification and the appended claims, wt. % is defined as the percentage of weight of a particular component is to the total weight/mass of the mixture. Vol. % is defined as the percentage of volume of a particular compound to the total volume of the mixture or compound. Mol. % is defined as the percentage of moles of a particular component to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the composition, mixture, suspension, ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

As also used herein, the term “about” when combined with a value refers to plus and minus 10% of the reference value. For example, a length of about 10 nm refers to a length of 10 nm±1 nm, a temperature of about 50° C. refers to a temperature of 50° C.±5° C., etc.

It is noted that ambient room temperature may be defined as a temperature in a range of about 20° C. to about 25° C.

As defined herein, a nanometric feature, e.g., a nanoparticle, is defined as having an average diameter in the nanoscale range of greater than 0 nanometers (nm) and less than 1000 nm. A micrometric feature, e.g., a microparticle, is defined as having an average diameter in the micron range of greater than 0 microns (μm) and less than 1000 μm.

The description herein is presented to enable any person skilled in the art to make and use the invention and is provided in the context of particular applications of the invention and their requirements. Various modifications to the disclosed embodiments will be readily apparent to those skilled in the art upon reading the present disclosure, including combining features from various embodiment to create additional and/or alternative embodiments thereof.

Moreover, the general principles defined herein may be applied to other embodiments and applications without departing from the spirit and scope of the present invention. Thus, the present invention is not intended to be limited to the embodiments shown but is to be accorded the widest scope consistent with the principles and features disclosed herein.

The following description discloses several preferred embodiments of spherical microparticles comprising agglomerates of nanopowder using emulsions and/or related systems and methods.

In one general embodiment, a composition includes a plurality of microparticles, where the microparticles comprise agglomerates of nanopowder, wherein the nanopowder includes a material selected from the following: a ceramic material, a metal, an alloy, a polymer, or a combination thereof. The microparticles are characterized by having an essentially spherical shape, nanograin features substantially identical to nanograin features of the nanopowder prior to formation into the microparticles, and a nanoscale porosity defined by the nanograin features. The plurality of microparticles have an essentially uniform size relative to one another. Moreover, the composition has flowability having a Hausner Ratio representing tapped density:bulk density less than 1.25.

According to another general embodiment, a method includes creating an emulsion having a plurality of spherical droplets by agitating a mixture comprising a suspension and a carrier fluid, curing the emulsion for causing the plurality of spherical droplets to form a plurality of spherical microparticles, and collecting the plurality of spherical microparticles. The suspension comprises a nanopowder and a solution, and the carrier fluid is immiscible with the suspension.

A list of acronyms used in the description is provided below.
3D three-dimensional
C Celsius
DHF 2,5-Dimethoxy-2,5-dihydrofuran
μm micron
nm nanometer
PEI polyethylenimine
PVA polyvinyl alcohol
SEM scanning electron microscopy
TBC thermal barrier coating
TGO thermally grown oxide
UHTC ultra-high temperature ceramic
Wm⁻¹K⁻¹ watt per meter kelvin, unit of thermal conductivity
YSZ yttria-stabilized cubic zirconia
ZrB₂ zirconium diboride

Various embodiments described herein include the preparation and production of spherical microparticles having agglomerates of nanopowder using an emulsion process. In one approach, the problem of poor flowability of nanopowders is solved by creating spherical agglomerates of nanopowders to form microparticles that display enhanced handleability while still maintaining nanograined characteristics. Using an emulsion process to produce spherical agglomerates allows for precise control of the density, size, and composition of the microparticle. This technique would be especially useful for refractory ceramics or metals whose angular particles have the tendency to lock up and further reduce handleability.

In recent years, production methods have opened the possibility of creating ceramic structures having higher porosity and lower density using advanced manufacturing techniques such as three-dimensional (3D) printing and spray coating. The powdered materials used in these processes need to be adequately flowable. Nanopowders, however, are typically cohesive and do not flow very well, and thus making them incompatible with a variety of processes such as spraying, three-dimensional printing, pouring, packing, etc.

One approach to change the flowability of nanopowders includes changing the particle size of the powder. However, this approach is not preferred since the nanoscale particle size is often the desired feature.

In one embodiment, the flowability of a nanopowder is improved by forming a spherical agglomerate of nanopowder particles. In a typical nanopowder composition, the nanoparticles having nanoscale lengths have interparticle forces that dominate the association of the particles to each other thereby resulting in poor flowability. Moreover, conventional nanopowder compositions include nanoparticles, and agglomerates of nanoparticles, that have misshapen, irregular particle shapes thereby making flow of the nanopowder difficult. In preferred approaches as described herein, the nanoparticles of a nanopowder form agglomerates in the shape of spheres since spheres tend to have a good flowability. The nanopowder particles combined together as a sphere thereby retain the nanometric feature characteristic of nanopowder particles, e.g., nanograins, aerogel structures, nanoparticles, etc.

In various approaches, the material comprised of spheres having nanometric features may be formed into a part, coating, etc. For example, a target structure (e.g., a part, a coating, etc.) may be formed with material including the spheres having nanometric features. Thus, the final material in the part, coating, etc. may have the material having nanometric features, formed from the agglomerate spheres. Moreover, in making the part, coating, etc., the material forming the part, coating, etc. has a preferably flowable characteristic imparted by the larger spheres comprising the nanometric features. As described herein, these processes allow nanometric material, e.g., material having nanoscale features such as nanograin features, to be compatible with a broader range of techniques, e.g., spraying, three-dimensional printing, etc.

According to one embodiment, an emulsion technique as described herein forms a plurality of spherical microspheres from a suspension of nanoparticles. The spherical shape of the agglomerates of nanoparticles imparts a flowability to the nanoparticle material. In other words, the emulsion technique as described herein may transform an un-flowable nanopowder comprised of nanoparticles to a flowable composition having the physical features of the nanoparticles, e.g., nanograin features, nanostructure, density, etc. In one approach, for example, an aqueous suspension of nanoparticles for forming a ceramic gel is immiscible with carrier fluids such as oils, silicone-based liquids, etc. and preferably forms a single emulsion of the nanoparticle suspension within the carrier fluid.

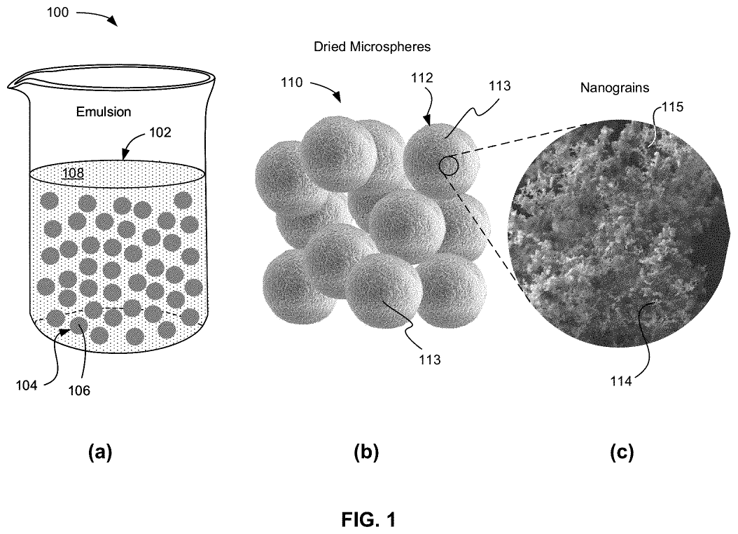

As illustrated in the schematic diagram of part (a) of FIG. 1, a process 100 of producing a material feedstock may include forming an emulsion 102 of suspension of nanoparticles (e.g., a sol-gel solution of metal boride nanopowder). The emulsion 102 includes a suspension of nanopowder that forms spherical droplets 104 comprised of, nanopowder particles 106, the spherical droplets 104 are present in a continuous phase of a carrier fluid 108 that is immiscible with the suspension fluid of the nanopowder particles 106 in the gelled droplets 104. For example, gelled spherical droplets comprising metal boride nanopowder are present in a continuous phase of an immiscible carrier fluid such as oil.

In one approach, the emulsion includes cure-able droplets (e.g., gelled droplets) comprising the suspended nanoparticles, and the cure-able droplets may be dried and fired to produce microparticles comprising agglomerates of the nanograined particles. As shown in part (b) of FIG. 1, the emulsion 102 may be dried and fired to form powder composition 110 that is comprised of a plurality of spherical microparticles, 112, e.g., microspheres, having agglomerates of nanoparticles 113.

According to one embodiment, a composition 110 includes a plurality of microparticles 112. The microparticles 112 may be characterized as having an essentially spherical shape. The plurality of microparticles 112 have essentially uniform sizes relative to one another. For example, the average diameters of the microparticles are essentially uniform, and the microparticles have essentially the same size as one another.

As shown in part (c) of FIG. 1, a magnified view of a portion of a spherical microparticle 112 illustrates the nanometric features, e.g., nanograin features 114, retained from the nanopowders suspended as gelled droplets 104 in continuous phase of the immiscible carrier fluid 108 of the emulsion 102. In some approaches, the nanometric features include nanograin features (e.g., nano-size crystallites) of the nanopowder material used to form the microparticles. The nanograin features 114 of the microparticles 112 are substantially identical to the nanograin features of the nanopowder prior to formation into microparticles. In addition, the microparticles 112 have a nanoscale porosity 115 defined by the nanograin features 114.

In various approaches, the average diameter of the nanograin features may be in a range of greater than 0 nm and less than 1000 nm. In preferred approaches, an average diameter of the nanograin features may be in a range of greater than 0 nm and less than about 100 nm.

In various approaches, the microparticles are particles having a largest diameter in a range of greater than about 5 μm to less than about 500 μm and may be larger. The plurality of microparticles have essentially uniform densities, such that the microparticles have essentially the same densities as one another.

The spherical microparticles include agglomerates of nanopowder, nanoparticles, nano-sized material, nanograin features, etc. The nanopowder may include one of the following materials: a ceramic material, a metal, an alloy, a polymer, etc. In some approaches, the nanopowder may be combination of materials, e.g., a ceramic material and a metal material, a ceramic material and a polymer, etc. In other approaches, the spherical microparticles may include nanopowders such nano-glass powder, nano-fibers, nano-capsules, nano-platelets, nano-tubes, quantum dots, or other types of nano-ceramic powders, etc.). In preferred approaches, the nanopowder is a non-oxide material. In an exemplary approach, the nanopowder is substantially free of oxygen.

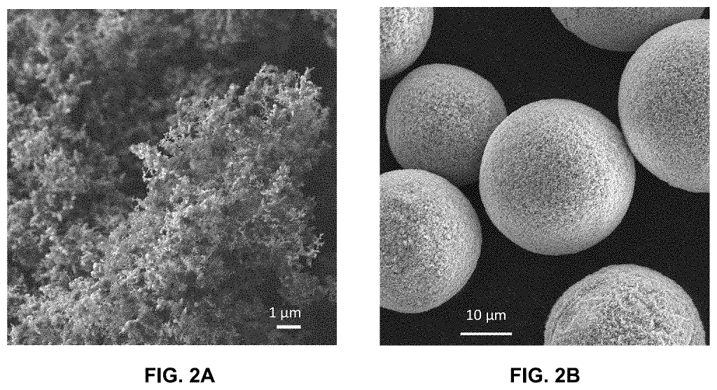

As an example only, the process as described herein may form metal boride spherical microparticles comprised of a metal boride compound having identical nanograins as the metal boride compound used to form the microspheres. As depicted in FIG. 2A-2B, metal boride microspheres as shown in the scanning electron microscope (SEM) image of FIG. 2B was formed from a starting metal boride compound (FIG. 2A) having identical nanograins and nanoscale porosity. The microspheres of FIG. 2B include the same nanograins and nanoscale porosity as the starting material as shown in FIG. 2A. Moreover, in this approach, the metal boride compound does not include oxide or boron impurities. The starting metal boride compound, e.g., nanopowder, may be made in the form of an aerogel that is composed of a network of sub-micron particles with a very fine porosity.

In various approaches, the process may synthesize microspheres of different porosity, e.g., solid, hollow, etc. In one approach, spherical particles with a uniform size (as shown in the image of FIG. 2B) may increase powder handleability while maintaining sub-micron grain features. In preferred approaches, the composition of the plurality of spherical microparticles is a powder having flowability. The flowability of the composition may be defined as the composition being flowable through a tube. The tube may be a nozzle, a funnel, a tube. In one example, the flowability of the composition may be further defined as being flowable through a tube having a pre-defined diameter under a pressure differential (e.g., an inlet/outlet system). In another example, the flowability of the composition may be further defined as being flowable through a tube having a pre-defined diameter under a directional force, e.g., gravitational force, mechanical force, etc. In one approach, the Hausner Ratio (tapped density/bulk density) of a powder could be used to determine flowability, where a result in a range of less than about 1.25 to 1.00 represents an ideally flowable powder. For example, and not meant to be limiting in any way, a nanopowder in a conventional form with misshapen, irregular agglomerates of nanoparticles may have a Hausner Ratio of 1.477; and then, using the same nanopowder to form spherical agglomerates of the nanopowder using the emulsion technique as described herein, the spherical agglomerate nanopowder may Hausner Ratio of 1.176.

In another approach, the angle of repose (angle measured from pile of powder poured onto flat surface) of a powder could be used to determine flowability. The angle of repose is not affected by the pile size, and technically any size pile allows measurement of the angle of repose for a powder. A typical test to measure an angle of repose may have a base of about 100 mm, often in the form of a raised pedestal so that the cone diameter will be fixed as long as enough powder is poured so that it flows off the edge. This approach to the test allows calculation of the angle by measuring the height.

An angle of repose can theoretically be between 0 and 90 degrees, where 0 would be theoretically perfect flowability. In real life applications, angles of 25 to 30 degrees are considered excellent, 31 to 35 degrees are good, 36 to 40 degrees are fair, 41 to 45 degrees are passable, 46 to 55 degrees are poor, 56 to 65 degrees is very poor, and >66 degrees is very, very poor. In one embodiment described herein, the powder comprising spherical microparticles may have an angle of repose less than 40 degrees, and preferably an angle of repose less than 25 degrees.

In one embodiment, a powder including the composition of a plurality of spherical microparticles may be used for fabricating a 3D structure using an additive manufacturing technique using a flowable powder, for example, selective laser melting, binder jet printing, spray coating, spray atomization, powder bed fusion, directed energy deposition, etc.

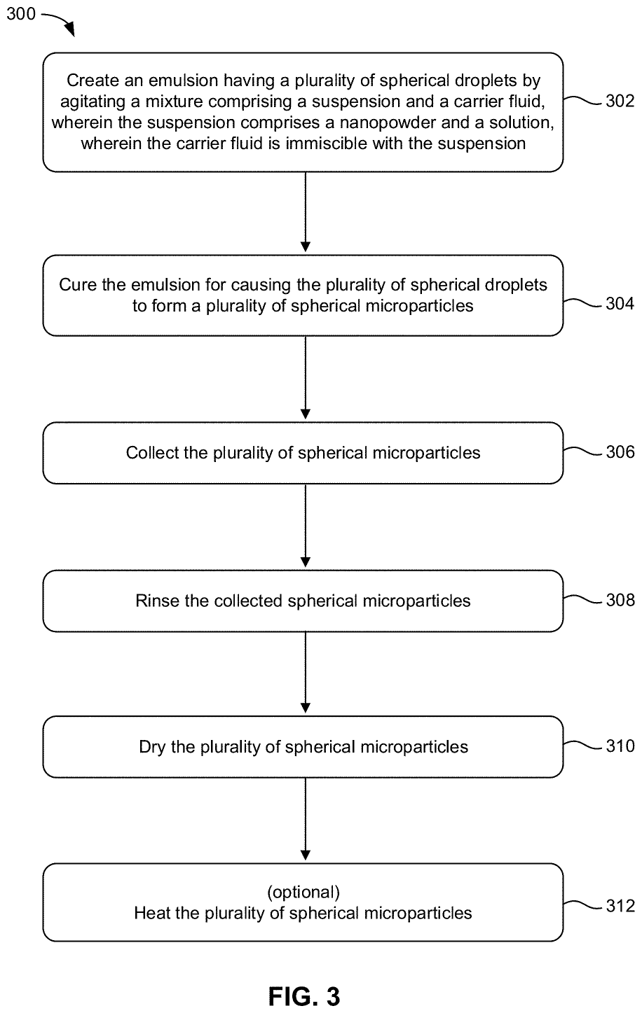

FIG. 3 shows a method 300 for forming a composition of spherical microparticles, in accordance with one embodiment. As an option, the present method 300 may be implemented to fabricate a plurality of spherical microparticles comprising a nanopowder such as those shown in the other FIGS. described herein. Of course, however, this method 300 and others presented herein may be used to [form structures for a wide variety of devices and/or purposes, provide applications] which may or may not be related to the illustrative embodiments listed herein. Further, the methods presented herein may be carried out in any desired environment. Moreover, more or less operations than those shown in FIG. 3 may be included in method 300, according to various embodiments. It should also be noted that any of the aforementioned features may be used in any of the embodiments described in accordance with the various methods.

In one approach of the method, a suspension of the nanopowder is formed, and then the suspension of nanopowder is combined with a liquid that is immiscible with the suspension of nanopowder. For example, if the nanopowder suspension is water-based, then the liquid may be an oil, which is immiscible with the water-based nanopowder suspension. The combined liquids are agitated (e.g., mixed, vibrated, etc.) to form an emulsion, where the nanopowder suspension forms spherical droplets in the oil (a water-in-oil emulsion), the droplets are cured (e.g., using cure chemistry), and then the cured droplets are removed from the oil phase and dried, thereby resulting in spherical particle agglomerates.

As described herein, according to one embodiment, a process for forming the spherical microparticle agglomerates includes a wet chemistry emulsion technique. Step 302 of method 300 includes creating an emulsion having a plurality of spherical droplets by agitating a mixture comprising a suspension and a carrier fluid.

The suspension includes a nanopowder and a solution. In various approaches, feedstock nanopowders may be processed for a variety of applications. The suspension of nanopowder feedstock suspended in the solution may be referred to as a slurry. Slurries are suspensions of powder mixed into a suspending liquid, e.g., a solvent. In general, the nanoparticles (e.g., nanopowders) added to the suspension may be any desired material that can be suspended in a liquid, e.g., with the assistance of agitation and/or suspending agent. Illustrative materials include metals, alloys, ceramics, glasses, polymers, quantum dots, capsules, platelets, tubes, fibers, etc. In exemplary approaches, the nanopowder includes at least one of the following materials: a ceramic nanopowder, a metal nanopowder, an alloy nanopowder, a polymer nanopowder, or a combination thereof.

In various approaches, composite microparticles may be produced by mixing multiple materials in the original suspension. For example, composite microparticles may include metal-ceramic, polymer-ceramic, glass-ceramic, etc. In some approaches, the composite microparticles may comprise nanoparticles having the same or different sizes. For example, the feedstock of nanopowder may include nanoparticles having substantially uniform average diameters relative to one another. In another example, the feedstock of nanopowder may include nanoparticles having a wide range of diameters.

In one approach, the composite microparticles may be mixed in any ratio, may include any number of different materials, etc. In one approach, composite particles may be used to create functionally graded materials or combined to form nanotechnology, bio-compatible polymer nanoparticles for drug delivery, etc. In one approach, the feedstock nanopowder (e.g., having a plurality of nanoparticles, nanograins, etc.) may be purchase commercially. The feedstock nanopowder may be referred to as the nanopowder of the target material. In some approaches, depending on the target material and its availability as a nanopowder, the nanopowder may be synthesized, fabricated, etc. (if not available commercially). In one approach, nanopowders having nanometric features may be synthesized by chemical reactions, thermal reductions, etc. In other approaches, a nanopowder having nanometric features of the target material may be obtained commercially. In one example, zirconium diboride, ZrB₂, may be synthesized from boron and zirconium precursors, using methodology disclosed in U.S. patent application Ser. No. 16/810,672, which is herein incorporated by reference, followed by reduction to a ZrB₂ powder. As an alternative example, ZrB₂ powder may be obtained from a commercial source.

In some approaches, depending on the application of the spherical microparticles, the nanopowder may be a non-oxide. In an exemplary approach, the nanopowder is a metal boride.

In various approaches, the nanopowder for suspension comprises the nanometric features such as particle size, grain size, pore size, etc. desired in the target coating, structure, etc. In one exemplary approach, the nanopowder may have nanograin features and a nanoscale porosity, where the nanoscale porosity may be defined by the nanograin features. In some approaches, an average diameter of the nanograin features may be in a range of greater than 0 nm and less than 1000 nm.

In various approaches, the suspension may include the nanopowder in a range of 1 vol. % to about 60 vol. % relative to the total volume of the suspension. In preferred approaches, the suspension may include the nanopowder in a range of 10 vol. % to about 50 vol. % relative to the total volume of the suspension.

In general, the solvent portion of the suspension (e.g., the solution of the suspension) may be any desired liquid capable of supporting the nanoparticles in suspension. Preferred liquids include water, alcohol, water-based solutions, alcohol-based solutions, etc. However, other liquids include acids, ethers, ester, organic liquids, oils, resins, molten solids, etc. As alluded to above, an additional material of known type may be added to the suspension in an effective amount to cause a particular effect associated with such additional material. For example, a known suspending agent may be used to enhance suspension of the nanoparticles.

In some approaches, the suspension may include an additive. In one approach, the additive may be a suspending agent included in the nanopowder suspension to maintain suspension of the nanopowder particles suspended in the liquid solution. Any known suspending agent suitable for the particular materials selected may be used. In one approach, a suspending agent includes polyethylenimine (PEI). An effective amount of suspending agent may be added to promote suspension of the nanopowder particles in the liquid solution. In one approach, a concentration of suspending agent may be less than 2 wt. % of nanopowder suspension.

In one approach, the suspension may include an additive that includes a gelling agent, curing agent, etc. added to the nanopowder suspension for solidifying the droplets of nanopowder in suspension. Preferably, a curing agent is added that gently starts the gelling of the nanopowder. A gelling agent, curing agent, etc. may be selected depending on the application of the nanopowder. For example, a gelling agent may be polyvinyl alcohol (PVA). Another gelling agent may be resorcinol and formaldehyde.

In various approaches, the amount of gelling agent added may be an effective amount for gelling a pre-defined amount of nanopowder added to the suspension. For example, for a suspension of ceramic nanopowder, an amount of PVA may be in a range of about 0.1 to 5.0 wt. % of added ceramic nanopowder, and preferably in a range of about 0.25 to 2.8 wt. % of added ceramic nanopowder. In another approach, an amount of the gelling agent may be up to about 15 wt. % of added ceramic nanopowder.

In one approach, a curing agent for phenolic gelation may be included. For example, for a sol-gel process, a resorcinol-formaldehyde gelling agent may be included the nanopowder suspension. In preferred approaches, the gelling agent, curing agent, etc. is added in a liquid form to the nanopowder suspension. In one approach, the curing agent may be added as a soluble solid. The gelling or curing agent may take a final form as a number of different material classes. In various approaches, the gelling or curing agent may include, for example and not meant to be limiting in any way, a polymer, organic material, inorganic material, metal, glass, ceramic, etc.

In some approaches, the curing agent is present to form a gel and form a network of the nanoparticles of the nanopowder. Types of curing agents may include active hydrogen-containing compounds and their derivatives, anionic and cationic initiators, crystallization of solutes, reactive cross-linking compounds, etc. In various approaches, a curing agent may be present in an effective amount for curing the nanopowder composition in the formed spherical droplets of the emulsion. In one approach, a curing agent may be referred to as a crosslinking agent. In one approach, a curing agent may be 2,5-Dimethoxy-2,5-dihydrofuran (DHF).

In one approach, the amount of curing agent (e.g., DHF crosslinker) may be typically added as a weight percent (wt. %) relative to the nanopowder. In one approach, a curing agent may be present in a range of about 0.1 wt. % to about 15 wt. % of the total weight of nanopowder. For example, the wt. % of the gelling agent (e.g., PVA) relative to the nanopowder may be 0.75%, and then the wt. % of the curing agent (e.g., DHF) relative to the nanopowder may be 0.50%. Alternatively, the amount of curing agent may be relative to the amount of gelling agent, for example, a composition includes 0.66 wt. % of DHF relative to PVA.

In one approach, the suspension may include a dispersing agent to make sure the particles remain suspended in the suspension, and the particles do not agglomerate, clump, etc.

In one approach, the suspension may include an additive such as an acid to control the pH of the final suspension. An acid as would be generally known in the art may be added in an effective amount to maintain a pH in a range of about 1 to 3, depending on the composition of nanopowder. Any known acid without adverse effects may be included in the suspension. For example, preferred acids include mineral acids, sulfonic acids, carboxylic acids, halogenated carboxylic acids, vinylogous carboxylic acids, etc. In one exemplary approach, the acid may include nitric acid.

Step 302 of method 300 includes a series of agitation steps for creating an emulsion of a nanopowder suspension and a carrier fluid. The first agitation sub-step includes applying mechanical energy to form a suspension of nanopowders in a solution. As described herein, a suspension includes mixing solid nanopowders into a liquid solution where the nanopowder particles stay suspended in the liquid solution and/or the particles are not allowed to settle out of the solution. Nanopowders tend to be fluffy and cohesive, and thus mechanical agitation is preferably used to suspend the nanopowders in the suspending solution.

In one approach, the nanopowder feedstock may be agitated in the solution using a resonant acoustic mixing to form a suspension. In some approaches of smaller scale production, e.g., in the mg to gram range, the process of applying mechanical energy may include one of the following: resonant acoustic mixing, planetary centrifugal mixing, etc. For example, a vertical mechanical mixing process such as the resonant acoustic mixing, may provide sufficient mixing of the nanopowder in the solution to form a suspension. In a preferred approach, the nanopowder feedstock may be agitated in the solution using planetary centrifugal mixing to form a suspension. In particular, for large scale production of spherical microparticles, e.g., at a kilogram scale, planetary centrifugal mixing may be a preferred method of mechanical agitation of the nanopowder suspension. Planetary centrifugal mixing includes a mechanical process of agitating materials using a combination of revolution, rotation, and three-dimensional flow of the materials. The revolution moves the material away from the center of the container by centrifugal force and rotation of the container, tiled at 45 degrees, causes the 3D flow of the material in the container during mixing.

In preferred approaches, the process of forming the suspension of the nanopowder and solution with a curing agent, acid, etc. includes a mixing in a planetary centrifugal mixer between additions of each component of the suspension.

Step 302 includes an emulsification of the nanopowder suspension with a carrier fluid that is immiscible with the suspension. In general, the immiscible portion of the emulsion, also referred to as the carrier fluid, may be any desired liquid that is immiscible with the liquid solution of the nanopowder suspension. Preferred substances include oils. However, other substances include water, alcohols, resins, alkanes, hydrocarbons, organic liquids, ethers, molten solids, etc.

In some approaches, if preferable, the carrier fluid and dispersed phase liquids may be reversed, for example, droplets of an oil-based suspension in a continuous phase of water compared to the inverse of droplets of a water-based suspension in a continuous phase of oil. For example, for a nanopowder suspension in a water-based, alcohol-based, etc. liquid solution, the immiscible liquid is preferably an oil. The immiscible liquid may be defined as a carrier fluid for the spherical microparticle agglomerates.

In some approaches, the viscosity of the solution of the suspension substantially matches the viscosity of the carrier fluid, such that the viscosity are within 100% of each other, and preferably within 50% of each other, but in exemplary approaches lower than 20% of each other. For example, a nanopowder suspension in a polar suspension may form a highly viscous solution (e.g., a nanopowder suspension having a high concentration of nanopowder particles), thus, mixing the highly viscous nanopowder suspension with a carrier fluid (e.g., an oil for an aqueous suspension) having a viscosity that matches the viscosity of the nanopowder suspension may allow better emulsion performance, thereby resulting in preferred formation of droplets of nanopowder suspension. Alternatively, a nanopowder suspension having a low viscosity may be matched with a carrier fluid having a similar low viscosity. The viscosity between the two liquids, the nanopowder suspension and the carrier fluid, is substantially the same. Silicone oils are available in a wide range of viscosities, from below 1 cSt to above 1000 cSt, and thus a silicone oil having a specific viscosity may be chosen according to the viscosity of the suspension.

In some approaches, the density and the viscosity of the components of the emulsion, e.g., suspension and carrier phase, may be tuned to form spherical microparticles that do not settle and do not coalesce. Without wishing to be bound by any theory, it is believed that an emulsion may be optimized if there is a difference in density between a suspension with a higher density compared to the density of the carrier fluid by including a carrier fluid having a higher viscosity. For example, for an emulsion having a suspension with a density of 1.9 g/cm² and an oil with a density of 0.9 g/cm², a matched viscosity of the oil with that of the suspension, may result in spherical droplets, but the droplets may settle too quickly and coalesce. Thus, to counter the difference in densities that may result in settling droplets that coalesce, an oil having a higher viscosity may slow down the settling process. For example, in one approach, a composition of an emulsion includes a suspension having a kinematic viscosity of approximately 30 cSt and a silicone oil having a viscosity of 500 cSt., and thus, a percent difference between the suspension and silicone oil may be as high as 180%.

In some approaches, the nanopowder suspension may be formed across a range of concentrations to adjust the density of the resulting spherical microparticles. In one approach, for forming spherical microparticles having lower density nanometric features, a lower solids loaded nanopowder suspension may be formed. For example, a low concentration of nanopowder may be suspended in polar solution for forming microspheres having large amounts of void space (porosity) between the nanoparticles which are connected by the curing agent to form a low density aerogel structure. In another approach, increasing the solids loading of nanopowder suspension of nanopowder comprising aerogel material may result in more dense spherical aerogels agglomerates. In various approaches, the concentration, composition, and/or particle size of the nanopowder may be controlled to tune the density of the resulting spherical microsphere agglomerates for various applications of flowable powder feedstocks.

In one approach, the carrier fluid may include an additive. In one approach, the carrier fluid may include a surfactant, such as a dispersing agent, surface energy modifier, etc., to stabilize the droplets of the dispersed suspension within the immiscible liquid and the subsequent continuous phase. The surfactant is a substance that may lower the surface tension between two phases. One type of surfactant is a dispersing agent, e.g., a dispersant. The dispersing agent allows the formed droplets to maintain a spherical shape and improves the separation between particles in a suspension. In addition, the dispersing agent prevents the droplets from touching each other and thus prevents the formation of larger droplets comprised of merged smaller droplets. In various approaches, a surfactant, surface modifier, etc. may be selected depending on the composition of the dispersed or continuous phase liquids. For example, the surfactant may be a silicone resin. In another approach, a surfactant may be the salt of a fatty acid. In preferred approaches, surfactant, surface modifier, etc. is added in a liquid form to the carrier fluid. Alternatively, surfactant, surface modifier, etc. may be added as a soluble solid to the carrier fluid. In some instances, it may be desirable to add the surfactant, surface modifier, etc. to the dispersed phase.

In various approaches, the amount of dispersing agent, e.g., surfactant, surface energy modifier, etc. is present in the carrier fluid in an effective amount to prevent the spherical droplets from combining. In some approaches, the amount of dispersing agent may be present in a range of about 2 wt. % to less than 100 wt. % of the carrier fluid, and preferably in a range of about 15 wt. % to about 25 wt. % of the carrier fluid.

In preferred approaches, the immiscible liquid forms a continuous phase, for example, the ratio of nanopowder suspension liquid to immiscible liquid is less than 1:1. In some approaches where the emulsion includes a means of ensuring discontinuity of the dispersed phase is used, such as surface energy modifications, tertiary phases, physical constraints, etc., a ratio of the suspension to immiscible liquid may be greater than 1:1. In one approach, a ration of the nanopowder suspension to the carrier fluid may be in a range of 1:1 to about 1:5. In one exemplary approach, an emulsion may include 80 wt. % of carrier liquid and 20 wt. % nanopowder suspension. For example, an emulsion includes 80 wt. % oil and 20 wt. % aqueous nanopowder suspension. The carrier fluid forms the continuous phase of the emulsion.

In some approaches, method 300 includes controlling the creation of the emulsion to form spherical droplets having average diameters in a pre-defined range. For example, the average diameters of the spherical droplets may be within 20% of each other, preferably within 10% of each other, or within 5% of a mean average diameter of the spherical droplets, etc.

In various approaches, the diameters of a majority of the spherical microparticles may not vary by greater than 40% from a mean average diameter of the plurality of formed spherical microparticles. For example, 70% of the formed spherical microparticles may have substantially a diameter in a range of 40% of the pre-defined average diameter. In preferred approaches, the diameters of a majority of the spherical microparticles may not vary by greater than 20% from each other, and ideally may not vary by greater than 10% of each other or by 10% from a mean average diameter of the spherical microparticles.

In some approaches, the method 300 may produce single and double emulsions for synthesizing solid and hollow microspheres of varying materials.

In one embodiment, a suspension-gelation (sol-gel) synthesis may be used to produce ceramics with sub-micron grain sizes as either monoliths, powders, microspheres, etc. The gel network cures and binds the ceramic particles together, allowing the user to form a wide variety of shapes and sizes. In some approaches, the density of this network may be tailored to a very wide range while maintaining the same grain size by tuning the solids loading of the suspension and subsequent drying method. Accordingly, properties of the gelled part such as strength, toughness, thermal conductivity, electrical conductivity, etc. of the gelled part may be tuned based on the amount of void space between the grains.

The second agitation sub-step of step 302 includes applying mechanical energy to form an emulsion of the nanopowder suspension with the immiscible carrier fluid, e.g., mixing an aqueous nanopowder suspension with an oil. The process includes agitating the nanopowder suspension in oil to form an emulsion of two distinct phases. The mechanical energy causes the emulsion of the nanopowder suspension and oil to break up and become a continuous phase of water-in-oil, where the nanopowder suspension liquid forms droplets within the oil phase. In preferred approaches, the continuous phase is the liquid that is immiscible with the nanopowder suspension liquid. In an exemplary approach, the continuous phase is oil. The droplet phase is the nanopowder suspension.

In preferred approaches, an emulsion is formed using resonant acoustic mixing. Resonant acoustic mixing allows mixing of viscous liquids by using high gravitational (g)-forces to create shear at liquid-liquid or liquid-gas interfaces. Adjusting g-force, suspension-oil ratio, and liquid-air ratio may affect final droplet size.

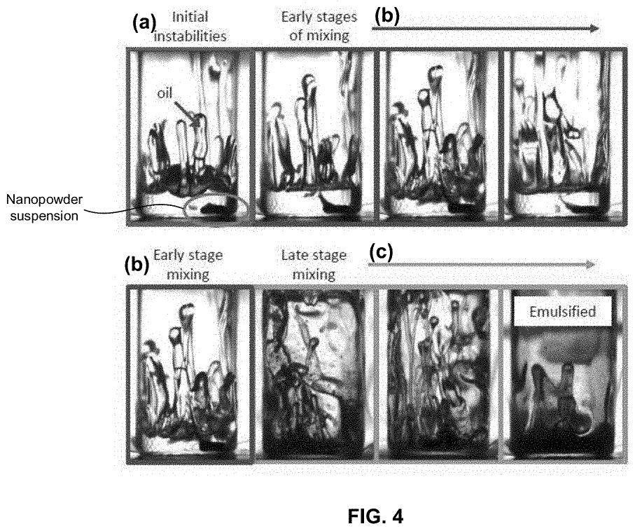

As shown in FIG. 4, slow motion still images reveal that nanopowder suspensions (circled material) of part (a) is sheared by fast-growing tendrils of oil at the unstable liquid-air interface. Part (a) shows the initial liquid-air instabilities forming. Early stage mixing by resonant acoustic mixing is shown throughout part (b). Part (c) illustrates late stage mixing where the suspended nanoparticles become emulsified in the carrier fluid.

Referring back to FIG. 3, step 304 of method 300 includes curing the emulsion for causing the plurality of spherical droplets to form a plurality of spherical microparticles. Once the droplets are formed to defined extent, the droplets of nanopowder suspension are cured to become solid agglomerate nanopowder spheres. In various approaches, the curing of the droplets may occur by at least one of the following: adding heat, raising the temperature of the system, adding chemical curing agents, by application of radiation, light, etc. In one approach, the emulsion of spherical droplets may be cured by placing the emulsion in an oven at a temperature in a range of 60° C. to 80° C. In another approach, the emulsion of spherical droplets may be cured at room temperature for a longer duration of time.

For various compositions, the duration of time for the curing may range from about 5 hours to about 36 hours, depending on the composition of the nanopowder. In some approaches, the curing of the emulsion may include simultaneous agitation of the emulsion during the curing step. For example, the emulsion may be placed on a ball mill, ball roller, etc. during the curing step at room temperature.

In some approaches, method 300 includes controlling the curing to cause the spherical microparticles to have densities in a pre-defined range. Preferably, the pre-defined range does not vary by more than 10% of the average density of the microparticles. In one approach, the amount of nanopowder used to form the suspension for the emulsion is closely related to the density of the formed spherical microparticles. For example, the addition of around 5 wt. % nanopowder to the suspension will generate spherical microparticles having very low density, and alternatively, addition of around 50 wt. % nanopowder may generate much higher density spherical microparticles.

In one approach, an emulsion formulation method produces spherical microparticle having nanopowder agglomerates and aerogel-level densities. For example, spherical microparticle agglomerates may have a less than 5% of theoretical maximum density. Alternatively, in some approaches, the spherical microparticles agglomerates may be used to produce densely-packed microparticle agglomerates for applications where a higher density is desirable. The approaches allow tunability of the mechanical properties (e.g., stiffnesses, strength, or toughness) of the microspheres. As described herein, the process has tunable flexibility that allows the process to be superior to other powder spheroidization techniques.

In one embodiment, in addition to particle density control, the emulsion technique described herein has the advantage of working with high-viscosity suspensions. This is particularly important when synthesizing microparticle agglomerates made of nanoparticles as the high surface area of the starting nanopowder often leads to high-viscosity suspensions that can cause clogging or flow issues in techniques like spray drying (e.g., similar to trying to spray honey out of a finely divided nozzle). In one approach, suspensions having a paste-like viscosity may be made into emulsions as long as the suspension liquid phase is immiscible with the carrier fluid. Microparticle agglomerates made using nanopowders offer a unique combination of the nanoparticle's characteristics (such as increased strength, increased surface area, decreased thermal conductivity, etc.) with the improved flowability and handleability of larger spherical microparticles. Moreover, the process as described herein allows careful control over the final packing density of particles using spray drying techniques.

Step 306 of method 300 includes collecting the plurality of spherical microparticles. In various approaches, the collecting of the spherical microparticles may include one of the following processes well-known to one skilled in the art: filtration, decantation, centrifugation, or a combination thereof. In one approach, step 306 includes removing the cured, solid agglomerates of nanopowder from the oil. In one approach, the solid agglomerates of nanopowder may be removed from the oil using a chemical approach. In one approach, the oil may be washed from the solid droplets physically by filtering, and then more steps of washing and drying the solid droplets allow the solid droplets to become dry solid spherical agglomerates of nanopowder.

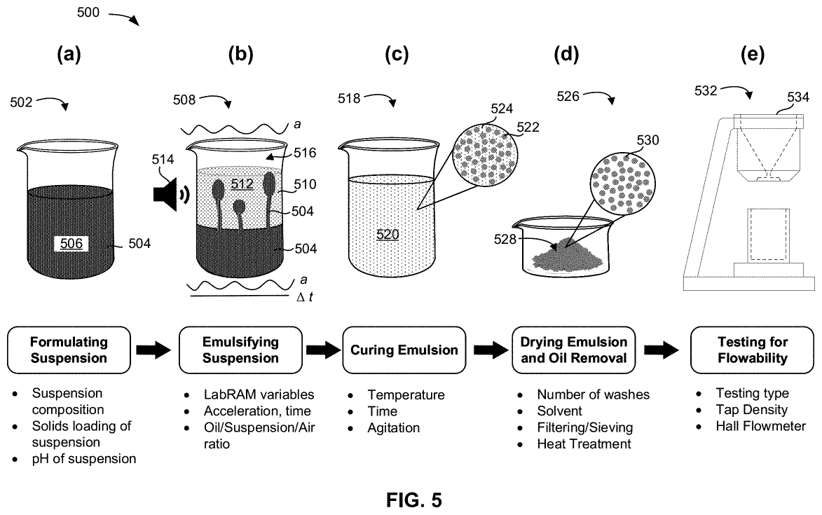

FIG. 5 is a schematic drawing of a series of steps for forming spherical microparticle according to a process 500 as described herein, according to one embodiment. Part (a) represents an initial step 502 of formulating a suspension 504. Formulating a suspension 504 includes determining the composition 506 of the suspension 504. In addition, the composition 506 includes determining the solids loading of suspension and pH of the suspension.

Part (b) represents the step 508 of emulsifying the suspension. A carrier fluid 510 is added to the suspension 504. The carrier fluid 510 may include oil 512. The carrier fluid/suspension may be mixed using a mixer 514, e.g., a LabRAM mixer, in which acceleration a and time Δt are variables for optimal emulsification of the carrier fluid/suspension mixture. The ratio of carrier fluid 510/suspension 504/air 516 may be considered for optimal emulsification and formation of spherical microparticles.

Part (c) represents the step 518 of curing the emulsion 520. The cured emulsion 520 includes cured microparticles 522 in a continuous phase 524. Step 518 includes consideration of temperature, time, and agitation during the curing.

Part (d) represents step 526 of drying and removing the oil from the microparticles. Collecting the microparticles 522 may include rinses, washes, etc. with a series of solvent(s) to remove the continuous phase 524 surrounding the cured microparticles 522. Step 526 may also include collecting the microparticles by filtering, sieving, centrifugation, etc. Step 526 may also include drying the rinsed microparticles in ambient conditions, heat treatment, etc. resulting in dried spherical microparticles 530. A plurality of the dried spherical microparticles may be in a powder form 528.

In various approaches, separation of the microparticles from the immiscible liquid may be achieved through conventional techniques, such as settling, filtration, drying, fluid exchange, etc. In one approach, filtration of the microparticles includes using a 10 μm paper filter for collecting microparticles and for removing contaminants.

Referring back to FIG. 3, the method 300 may include a step 308 of rinsing the collected spherical microparticles. The rinsing/washing may involve one or more steps of fluid exchange with a solvent, fluid, etc. The particles may be washed to remove the continuous phase, e.g., washed in hexane, chloroform, etc. In one approach, the rinsed particles may be filtered between rinsing steps. For example, a wash step may include rinsing the collected cured microparticles in hexane, chloroform, etc. to remove the oil phase.

In one approach, the rinsing of step 308 may include a fluid exchange with a similar type of carrier fluid having a lower viscosity. In one approach, an emulsion having oil as the carrier fluid/continuous phase may be treated to a fluid exchange with another type of oil having a lower viscosity than the oil in the continuous phase. For example, an emulsion having spherical microparticles in a very high viscosity silicone oil, and thus, the first washing step may include a fluid exchange with a low viscosity silicone oil. The first washing allows the removal of a significant amount (greater than about 90%) of the high viscosity oil which is not volatile (i.e., is not easily evaporated) with a low viscosity oil that is volatile such that the low viscosity oil may be evaporated or easily washed away by solvents such as hexane, chloroform, toluene, etc. The rinse/wash step may include a first rinse step of a liquid exchange with an oil before the solvent exchange step.

Referring back to FIG. 3, following rinsing the spherical microparticles, method 300 may include a step 310 of drying the spherical microparticles. In one approach, the particles may be dried in a process that includes chemical washes and drying. In one approach, particles may be dried to remove the chemical wash/rinses (e.g., hexane, chloroform, etc.) at a temperature in a range of ambient room temperature up to 80° C. In one approach, drying of the spherical microparticles may include heating the composition at a temperature of less than 200° C., preferably 100° C., for about an hour to remove humidity effects that might affect the flowability of the microparticles.

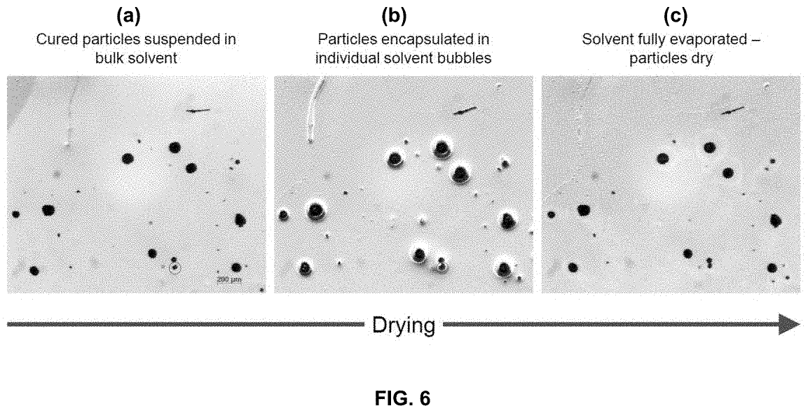

In one example, a time lapse of a drying process of a field of cured spherical microparticles is illustrated in images of FIG. 6. The images illustrate the particles dried in a final rinse of bulk solvent. Part (a) shows the cured particles suspended in a bulk solvent such as hexane, chloroform, toluene etc. Part (b) shows particles encapsulated in individual solvent bubbles as the majority of the solvent evaporates away. Part (c) shows the particles after the drying process where the solvent has been fully evaporated, and the particles are dry.

Looking back to FIG. 5, collections of spherical microparticles may be tested for flowability. In part (e), step 532 includes testing spherical microparticles 530 for flowability. Various types of flowability tests may be used to test the flowability of the spherical microparticles 530. In one approach, a tap density of the powder 528 comprising spherical microparticles 530 may be assessed. In one approach, a hall flowmeter 534 may be used to determine the flowability of a powder 528 comprising spherical microparticles 530.

Emulsification Techniques

In one approach, the emulsification of the suspension and carrier fluid mixture may use an emulsifying technique such as resonant acoustic mixing, lab-scale batches may be emulsified in under a minute. In some approaches, droplets may cure at room temperature. In other approaches, the rate of curing may be increased with application of heat, elevated temperature, etc. In one approach, scale up to bulk production may be possible with increasing container size and batch volume while keeping mixing parameters constant.

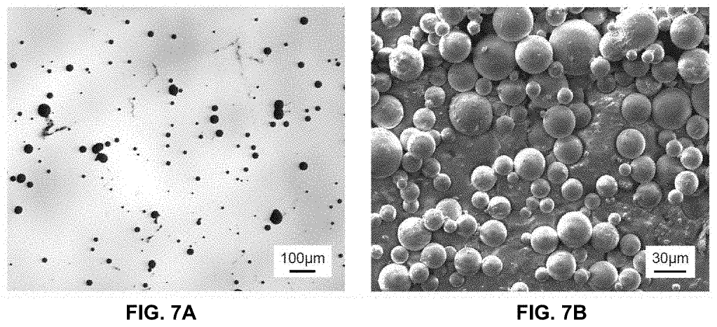

FIG. 7A-7B depict images of spherical microparticle agglomerates formed using a resonant acoustic mixing technique to form an emulsion of the nanoparticles suspended in immiscible liquid. FIG. 7A is an optical image of a wet preparation of spherical microparticle agglomerates formed after curing. FIG. 7B is an SEM image of dry spherical microparticle having agglomerates of nanopowder. In one approach, spherical microparticle agglomerates are formed having nanometric features.

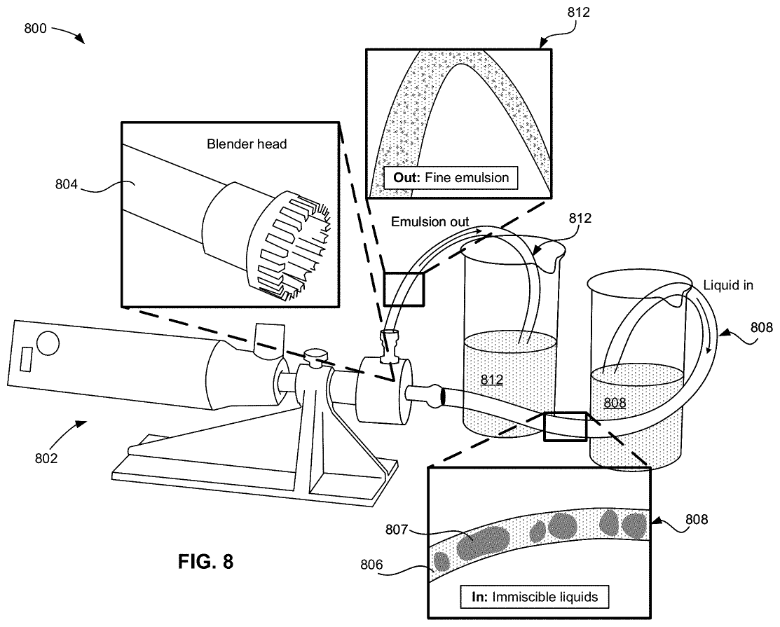

In another approach, an emulsion may be formed using inline blending. FIG. 8 illustrates an example of a system for inline blending 800. A homogenizer 802, for example, an IKA Inline Homogenizer (Wilmington, N.C.), may be used for large delivery capacity of 4.4 to 11.6 liters/minute with open outlet. The system of inline blending 800 allows air-free, sterile, and inline suspension emulsifying. The process may include vacuum or pressurized operation (up to 6 bar). In one approach, a pump may be integrated between the intake nozzle and vessel, such that viscous fluids may be processed.

As shown in FIG. 8, a “liquid in” may include the immiscible liquid 806 for forming the mixture 808 of immiscible liquid with suspending the nanopowder particles 807. The mixture 808 passes through the blender head 804 of the homogenizer 802, and then is pumped as a fine emulsion 812 of the immiscible liquid 806 and nanopowder particles 807 and collected as “Emulsion out.”

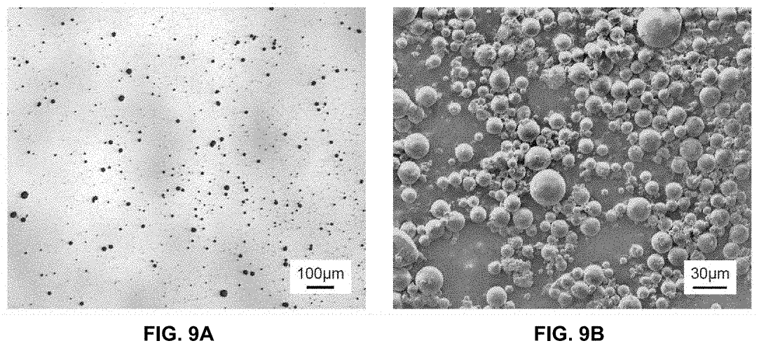

FIG. 9A-9B depict images of spherical microparticle agglomerates formed using the immersion blender, e.g., inline blending, to form an emulsion of the nanoparticles suspended in immiscible liquid. FIG. 9A is an optical image of a wet preparation of spherical microparticle agglomerates. FIG. 9B is an SEM image of dry spherical microparticle agglomerates.

Referring back to FIG. 3, as an option, method 300 may include step 312 of heating the collected dry spherical microparticles to a temperature range of greater than 200° C. to less than 3000° C. In some approaches, the heat treatment of step 312 may be used to burn away contaminants, densify the particles, etc.

According to one embodiment, the process described herein, e.g., an emulsion agglomeration process, tends to be flexible and may be applied to any powdered material that can be suspended in a liquid. The process of forming spherical microparticle agglomerates produces flowable nanopowders while maintaining fine grain size of the nanometric features. In one approach, the spherical microparticle agglomerates are compatible with conventional thermal spray systems. In one approach, the spherical microparticle agglomerates may withstand higher temperatures than conventional material used in thermal spray systems. In one approach, the process of forming spherical microparticle agglomerates allows tunability of particle size and morphology. Moreover, in various approaches, the compositions of the components and the characteristics of the components may be tailored for forming a predefined spherical microparticle agglomerates.

The average diameter of the spherical microparticle agglomerates is selectable by adjusting process parameters such as amount of agitation applied, agitation method, immiscible liquids selected, the liquid-liquid viscosity ratio, curing time, surfactant concentration, etc., and generally approximate to the size of the droplets formed in the emulsion. A minimum size of the spherical microparticle agglomerates may depend on the average diameter of the nanoparticles that comprise the initial nanopowder. The spherical microparticle agglomerates have an average diameter greater than the average diameter of the nanoparticles of the initial nanopowder.

Accordingly, the average diameters of the spherical microparticles having agglomerates of nanopowder may vary, ranging from 100's of nanometers (nm) up to several millimeters (mm) but the average diameters may be lower or higher. The smaller diameters of the spherical microparticles correlate to the average diameter of the particles of the feedstock nanopowder. For nanopowder having nanoparticles with an average diameter of about 20 nm, smaller size microparticles may form, e.g., having an average diameter of 5 μm. However, the surface of the smaller microparticles have physical characteristics such as a rougher surface showing the fewer numbers of nanoparticles forming the microparticle. Larger microparticles, e.g., an average diameter of 30 μm, having the same nanopowder composition of small diameter nanoparticles have physical characteristics of a smoother surface. In one approach, for applications including a flowable powder, an average diameter of the spherical microparticles may be a range of 10 microns (μm) to 30 μm, but as alluded to above, can be higher or lower than this exemplary range.

In other approaches, larger spherical microparticles might be in a range of 1 to 5 mm, formed by dropping a droplet of suspension in oil, for example, without added mechanical energy to retain the larger size of the spherical droplets. In these approaches, formation of the larger sized microparticles includes the two immiscible liquids and chemistry of the compositions to form the spheres. These products may also include ceramic compositions such as carbides, borides, etc.

The size of the nanometric features, e.g., nanograin features, within the spherical microparticle agglomerates may have an average diameter in a range of greater than 0 nm and less than 1000 nm. In an exemplary approach, an average diameter of nanograin features of the spherical microparticle may be in a range of 30 nm to 60 nm, but again, can be higher or lower than this exemplary range. The nanometric features of the spherical microparticle agglomerates may include nanograins, aerogel structures, nanoparticles, nanopores etc. The nanograin features of the agglomerates of nanopowder comprising the spherical microparticle are retained from the feedstock nanopowder.

As noted above, the nanoparticles usable in the suspension may be purchased or synthesized. Moreover, the composition of the spherical microparticle agglomerates may be different than the composition of the nanoparticles. For example, in one embodiment, boride nanopowders may be produced through a sol-gel process followed by a borothermal reduction. This process allows for tremendous flexibility to produce borides with sub-micron grain sizes as either monoliths, powders, microspheres, etc. Briefly, according to one embodiment, the process includes forming a sol-gel, which is a network of boron or boron carbide nanoparticles coated with the corresponding metal oxide, and then the sol-gel is dried and then fired at an elevated temperature (e.g., 1100° C.) to reduce the metal oxide to the final boride phase.

Applications

The metal blades used in gas turbines are subjected to higher temperatures and harsh chemical environments. Operating gas turbines at higher temperatures increases their efficiency; however, the current stabilized zirconia coating systems used for turbine blade thermal barrier coatings (TBCs) have higher oxygen transparency that leads to interlayer growth and subsequent failure of the coating material over time. As described herein, this problem may be solved through targeting the coatings, e.g., the TBCs, of the turbine blades with the use of non-oxide compounds such as metal borides and carbides that would limit oxygen diffusion, prevent interlayer growth, and function more effectively than traditional oxides at higher temperatures.

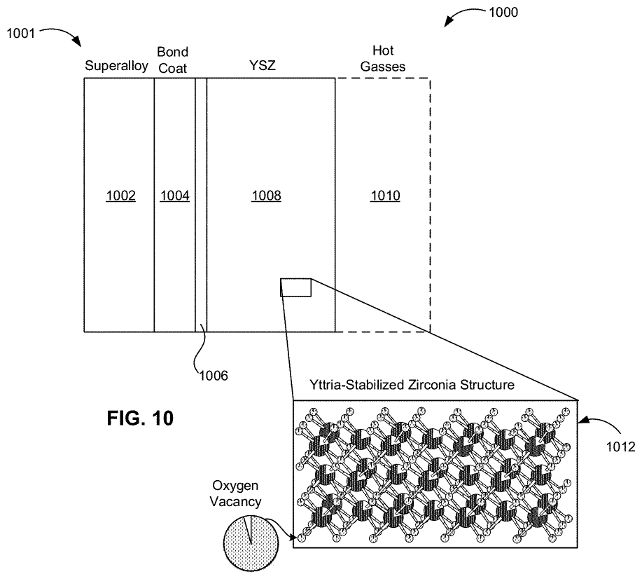

A modern conventional TBC-coated structure is typically a 4-layer structure: 1) the metal superalloy substrate, 2) a bond-coat layer, 3) a thermally grown oxide (TGO) layer formed by oxidation of the bond-coat and 4) a higher temperature ceramic outer layer. As illustrated in FIG. 10, a schematic drawing of a portion 1001 of a conventional TBC 1000 of a turbine blade may include a superalloy substrate 1002, a bond coat layer 1004, a TGO layer 1006, and a ceramic outer layer 1008. The outer ceramic layer 1008 of the TBC 1000 is in contact with the hot gasses 1010 of the system.

In conventional use, turbine blades have zirconia oxide ceramic coatings. In particular, as shown in FIG. 7, the coating yttria-stabilized cubic zirconia (YSZ) is currently the material of choice for the ceramic top-coat ceramic outer layer 1008 as it has lower thermal conductivity, a higher melting temperature and a coefficient of thermal expansion similar to the superalloy substrates. TBCs allow turbine blades to operate with flowing gas temperatures higher than the melting temperature of the blade alloy. As both the superalloys and TBC materials advance over time, the operating temperature of gas turbines increases. Because of the power and thermal efficiency gains seen with increased operating temperature, there is an obvious desire to further advance the functional temperature range of TBCs. As the industry pushes to increase turbine operating temperature, the standard TBC coatings are beginning to fail earlier and with greater frequency.

Moreover, in turbine blade systems, a large difference in coefficient of thermal expansion between two layers will cause stress to build up at the interface as the temperature changes. This stress can lead to failure at the interface and therefore needs to be minimized, especially as the temperature range increases. In conventional metal blade substructures, a TBC compound with a coefficient of thermal expansion closely matches that of the superalloy, which severely limits viable material candidates.

Moreover, referring to FIG. 10, formation and buildup of the interface, the TGO layer 1006, in between the ceramic outer layer 1008 (e.g., topcoat layer) and the bond coat layer 1004, may have a drastically different thermal expansion coefficient and lead to failure of the TBC after prolonged thermal cycling. For example, the oxygen vacancies of the YSZ structure 1012 of the ceramic outer layer 1008 contributes to the formation of the TGO layer 1006.

Thus, it would be desirable to prevent the large thermal expansion mismatches within the TBC or between the TBC and the metal blade substructure. According to one embodiment described herein, a composition gradient from the superalloy substrate through the TBC to the ceramic outer layer (e.g., topcoat) may minimize the effect of thermal expansion mismatches while simultaneously increasing bonding and adhesion.

One of the main functions of a TBC is protecting the metal substructure from oxidation. The TBC needs to prevent direct contact with oxygen-containing hot gasses as well as minimize diffusion of oxygen through the material itself. YSZ as a compound is extremely oxygen-transparent. This means that even a fully dense YSZ coating will still allow the diffusion of oxygen toward the underlying metal substrate.

What is needed, and absent in the art, but provided by the present disclosure, is a new material system, for example, non-oxide UHTCs with small particles and fine grains, for next-generation high-temperature gas turbines. Moreover, in one approach, keeping the particle size small (10-20 μm) may allow for a finely structured gradient and minimize the overall coating thickness.

As various embodiments describe herein, the outermost layer of the TBC preferably remains stable in the presence of oxygen at elevated temperature without major material loss or undesirable phase transformation. Oxide compounds have the obvious advantage here as they will not oxidize further, however a non-oxide ceramic TBC made with the right compound may form a very thin layer of surface oxide that prevents further oxidation of the bulk. Some reports of certain ultra-high temperature ceramics (UHTCs) such as zirconium and hafnium diboride have demonstrated resistance to oxidation at temperatures above 3000° C. through the formation of a thin, stable oxide layer.

In conventional systems, increased operation temperature will cause the surface of the turbine blades to exceed the melting temperature of the superalloy, therefore, the TBC needs to minimize thermal conductivity normal to the surface to insulate the metal substructure. YSZ has one of the lowest thermal conductivities (˜2.3 Wm⁻¹K⁻¹ at 1000° C.) and may be an appropriate surface coating. Although the proposed non-oxide alternative compounds have higher thermal conductivities, scattering of heat conducting phonons can be increased by reducing grain size and/or increasing porosity to bring the thermal conductivity down to an acceptable level.

In one embodiment, a product may include a ceramic coating of a composition of spherical microparticles as described herein. The product includes the ceramic coating having the nanograin features and the nanoscale porosity of the microparticles. Further, the ceramic coating may have the physical features characteristic of spraying, such as a uniform thickness, absence of applicator marks, etc.

In one example, a non-oxide ceramic coating may be used as coatings for higher temperature locations in corrosive environments. A non-oxide ceramic coating having nanograin features and nanoscale porosity may have higher melting temperatures. The non-oxide composition that forms the non-oxide ceramic coating does not include an oxygen component. Thus, the non-oxide ceramic coating has a crystalline structure that does not include an oxygen component. Moreover, the composition of the non-oxide ceramic coating does not promote oxygen diffusion. In sharp contrast to a conventional ceramic coating that provides a crystallographic pathway for oxygen diffusion, the non-oxide ceramic coating as described herein may act as an efficient oxygen barrier by preventing the diffusion of oxygen through the material.

However, without wishing to be bound by any theory, it is believed that small amounts of trapped oxygen may be present in the non-oxide ceramic coating. For example, application of the non-oxide composition, e.g., by a plasma spray process, may include small amounts of oxygen present on the surface of the particles, and the trapped oxygen may survive the application process and be present in the coating, small amounts of oxygen may be incorporated into the non-oxide ceramic coating as a trapped impurity, e.g., within the crystal structure of the main compound, within a small region of a secondary oxide phase, etc.

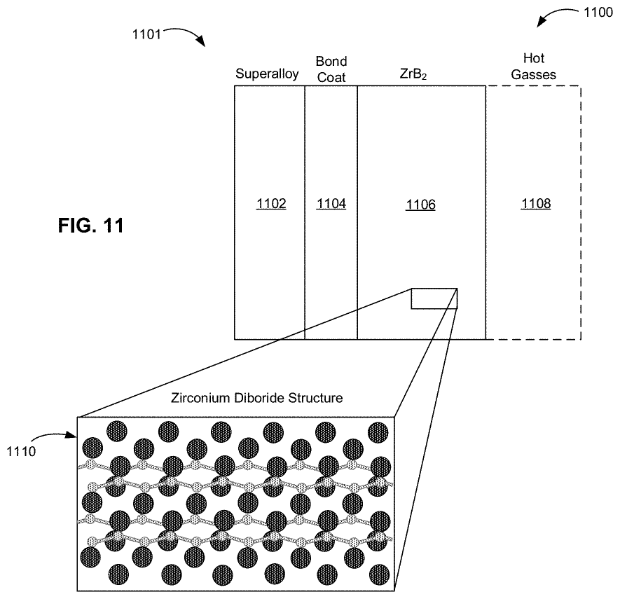

According to one embodiment, a TBC of a turbine blade includes a non-oxide ceramic, as shown in the schematic drawing of a portion 1101 of TBC 1100 in FIG. 11. In one approach, TBC 1100 may include a superalloy substrate 1102, a bond coat layer 1104, and a ceramic outer layer 1106. The outer ceramic layer 1106 of the TBC is in contact with the hot gasses 1108 of the system. In one approach, the ceramic material 1110 of the outer ceramic layer 1106 may include a non-oxide ceramic, for example, a zirconium diboride. As shown in the magnified view of the ceramic material 1110, a zirconium diboride structure does not include oxygen and thus is not oxygen transparent.

In one embodiment, the use of non-oxide ceramics as a coating of turbine blades is preferred because of the robust higher melting temperatures and absence of an oxygen component. Moreover, non-oxide ceramics may serve as efficient oxygen barriers by preventing the diffusion of oxygen through the TBC. In some approaches, the outer layer coating may include non-oxide compounds with both nanometer-scale particles and wide range of ultra-fine porosities. In one approach, borides and carbides may be synthesized as ultra-low-density foams. In another approach, the outer layer coating may include non-oxide compounds with nanometer-scale particles concentrated to high density.

An alternative solution for an outer layer coating may include non-oxide compounds; the atomically dense and oxygen-free crystal structures that limits the diffusion of oxygen atoms. Once the surface of a non-oxide compound has oxidized, it acts as a barrier and prevents any further oxidation, thereby protecting both the metal substrate and the TBC itself.

In various approaches, depending on the solids loading of the sol-gel and subsequent drying method, the density of the network of the metal boride compound may be tailored to a very wide range while maintaining the same grain size. Moreover, thermal conductivity of the particles may be tuned based on the amount of void space between the grains. In some approaches, tuning the thermal conductivity of the material may define a graded coating system. For example, in one approach a coating may have a gradient of thermal conductivity in a thickness direction of the coating. For example, in one approach, multiple layers may be built up to produce a coating where each layer is a composite with a different ratio of material A (base) to material B (outer layer), where the ratio may change gradually as the layers are added to a structure. For example, material property mismatches of the coating may be accommodated thereby minimizing debilitating added stress typically built up due to material property mismatches within the coating and between the coating and the part.

According to various embodiments as described herein, material that may otherwise have higher thermal conductivity, e.g., monolith non-oxide ceramic material, can be transformed into lower density non-oxide ceramic material having nanometric features and optimal lower thermal conductivity and applied to additive manufacturing techniques such as spray coating. For example, ZrB₂ aerogel material may be used as a preferable insulator material. Moreover, using methods described herein for forming spherical microparticles having nanostructure features, e.g., nanopowders, would allow spherical ZrB₂ nanopowder agglomerates to have critical compatibility with thermal plasma spray techniques used for coating.

Plasma spray coating of materials generally involves powder flowing through a tube through a hot plasma torch and that plasma torch heats up the powders and sprays the powders onto the target surface where the powders melt into a coating on the surface. It is critical in the process of plasma spray coating that the particles of the powder are flowable for spraying on a surface. Thus, in a preferred embodiment of coating turbine blades, it is critical for the particles of non-oxide nanopowders to be flowable to be used in plasma spray techniques. The plasma spray parameters may be tuned to minimize or forego melting of the nanograins if desirable.

In various additive manufacturing techniques, material having flowable particles as described herein is preferred for three-dimensional printing of nanopowders. For example, in binder jet printing, spreading a layer of powder on a surface, followed by an ink jet application of binder in a pattern, followed by spreading a second layer of powder on the binder pattern layer, and the alternating layers of binder and powder form a structure. In these processes, a flowable powder having nanometric features would be critical for forming geometric structures having multiple layers.

In other approaches, flowable powders as formed in spherical microparticle agglomerates may be used in additive manufacturing processes needing flowable dry powders, e.g., selective laser melting, binder jet printing, spray coating, spray atomization, powder bed fusion, directed energy deposition, etc. In other approaches, the spherical agglomerates may be made into a suspension and used as an ink in additive manufacturing, e.g., extrusion-based printing, ink jet printing, etc.

In other approaches spherical microparticle agglomerates may be used to create a coating with increased toughness (the amount of energy per unit volume that a material can absorb before failing), mechanical strength, etc. In one approach, the combination of nanoparticle and gelled or cured network within the microparticle may be tailored, tuned, engineered, etc. to result in a material toughness of the resulting composite that may be greater than an individual component.

In other approaches, the spherical microparticles comprising agglomerates of nanopowder may be used for dye techniques such as hot pressing. The flowability of the spherical microspheres allows the dye to be filled with the powder evenly with precise amounts of the powder. Moreover, the spherical shape of the microparticles imparts improved packability of the powders into dyes, molds, around templates, etc.

In one approach, hard ceramic spherical microspheres may be used as a geological province. In one approach, the hard ceramic spherical microspheres may be used to produce engineered proppants for hydraulic fracturing operations. Fractures are opened in shale formations by pressurizing a wellbore with some sort of fluid. The presence of proppants ensure fractures stay open to promote oil and gas recovery through the well. Currently well sorted quartz sand is most typically used as a proppant, in addition to resin coated sand and bauxite beads. In preferred applications, the roundness and monodispersity of proppants formed as described herein would allow good transport into fractures. Moreover, the strength and hardness of a sintered ceramic or mineral, formed as described herein, are preferably for preventing the fracture from closing. Weak or less mechanically hard materials may be susceptible to being crushed, and if the material is not well-sorted the particles may interfere with oil or gas permeability through a fracture rather than increase it.

In one approach, ceramic nanoparticles and the gelling or curing agent forms a polymer thereby creating a nanoceramic-polymer composite particle. These nanoceramic-polymer composite coatings may display enhanced properties such as toughness, strength, etc. compared to a monolithic part of the same ceramic material.

According to one embodiment described herein, spherical microparticle agglomerates including nanopowder with the preferred nanograin structure have been engineered to have flowability compatible for thermal plasma spray techniques.

In order to reduce thermal conductivity by increasing phonon scattering, a nanograin size of about <100 nm of the non-oxide component of the TBC is preferable. In one approach, an outer coating layer having small grain size has been shown to enhance structural stability in TBCs. While small particles can lead to small grains, small particles may also decrease powder flowability and handleability.

In order to maintain a small grain size while making the powders suitable for commercial coating techniques such as plasma spraying, the sol-gels may be formed into fine-grained microspheres using the emulsion technique as described herein. In one embodiment, an ethanolic sol-gel suspension used to synthesize the metal borides is immiscible with fluids such as silicone-based liquids and may preferably form a single emulsion of the nanoparticle suspension in the carrier fluid, which can be dried and fired after gelling just like the monolithic form.

An important aspect to the development of a successful replacement to the current TBC material system is the ability to adapt to commercial coating processes. Thermal spray coating is a mature and widespread technology that is already in use by numerous companies across the country to apply TBCs onto turbine blades. By forming the non-oxide nanopowders into agglomerate microparticles as described herein, the powders will, for the first time, display adequate flowability to be used in the thermal spray process.

Any of the methods, systems, devices, etc. described above, taken individually or in combination, in whole or in part, may be included in or used to make one or more systems, structures, etc. In addition, any of the features presented herein may be combined in any combination to create various embodiments, any of which fall within the scope of the present invention.

Experiments

Production of Spherical Ceramic Particle Agglomerates

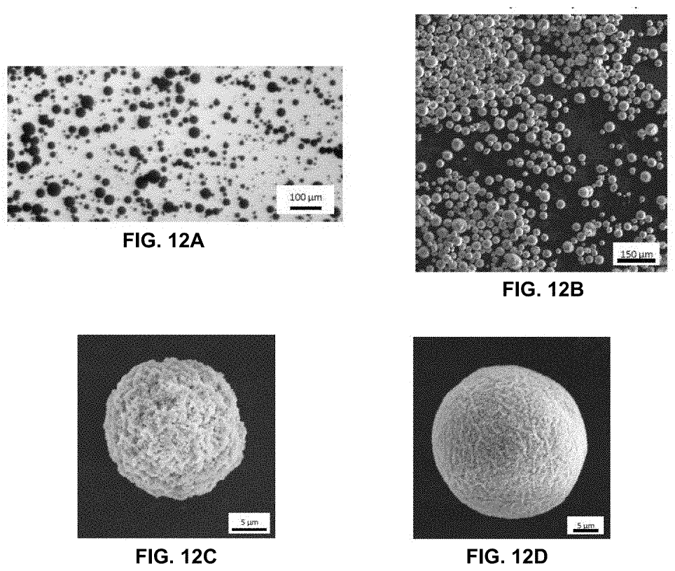

FIG. 12A is an optical image of cured ceramic spherical microparticle agglomerate droplets in silicone oil. The nanopowder was suspended with a surfactant in water and mixed with high-viscosity silicone oil to form an emulsion. Mechanical energy was added to the emulsion to form droplets on the order of 10's of microns (μm). Droplets were cured and then removed from the oil, rinsed with alcohols, and dried to form the microparticle powder shown in FIG. 12B.

FIG. 12B is an image of dried spherical microparticles as a powder. The particles of a ZrB₂ nanopowder may be formed using two different processes. FIG. 12C is an image of an individual dried microparticle formed with nan zirconium diboride (ZrB₂) suspended in water and emulsified with oil by resonant acoustic mixing. ZrB₂ grains on the order of about 60 nm.

In another approach, FIG. 12D depicts an image of an individual dried microparticle formed by combining nano boron (B) and nano zirconia (ZrO₂) in suspension and emulsified by resonant acoustic mixing. The emulsion was reduced to form zirconia diboride (ZrB₂).

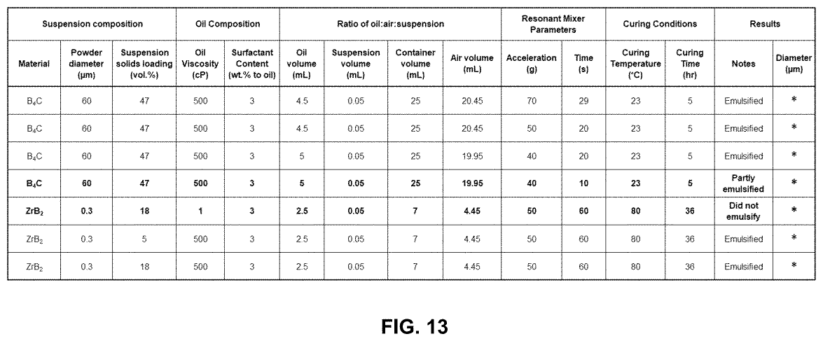

FIG. 13 is a table that summarizes the factors that affect and control particle size. The two general types of factors that can be controlled are chemical (suspension composition, oil composition, surfactant concentration, curing temperature, curing time, etc.) and physical (ratio of oil:suspension, ratio of liquid:gas, resonant acoustic mixing g-force, mixing time, etc.). Chemical and physical modifications can be made independently of each other or together to adjust final microparticle size. Some modifications may result in poor or incomplete emulsification (see bold boxed rows).

Determining Average Particle Size

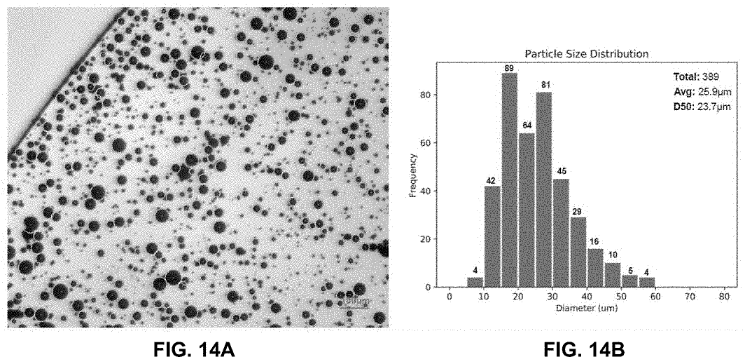

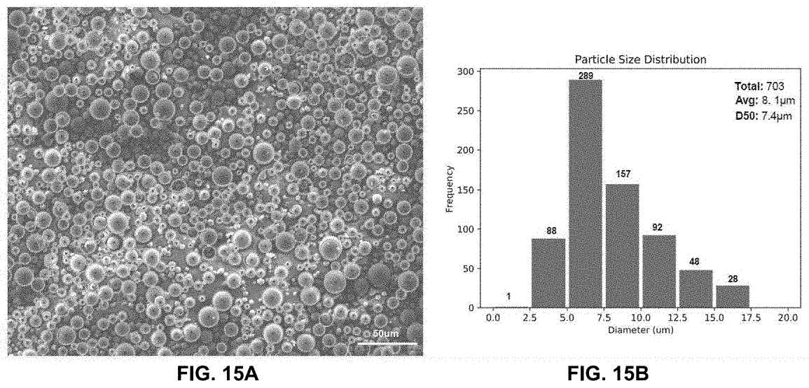

Average size of spherical particles were determined using Hough Transformation using a software program, according to one embodiment. Images can be taken optically while droplets are still suspended in oil as shown in FIG. 14A or after drying as shown in FIG. 15A. FIG. 14B shows the distribution of particle size of the particles shown in the image of FIG. 14A.

FIGS. 15A and 15B show average size of spherical particles determined using Hough Transformation using the software program, according to one embodiment. Images were taken by scanning electron microscopy after particles were dried as shown in FIG. 15A. FIG. 15B shows the distribution of particle size of the particles shown in the image of FIG. 15A.

Uses

In various embodiments, powder handleability and particle density control is an important consideration for a wide variety of both traditional and advanced manufacturing techniques, including but not limited to: dry spraying, thermal spraying, powder bed printing, binder jet printing, mold and die loading, ceramic preforming, etc.

In addition, in one embodiment, the spherical agglomeration technique may be used to form a variety of materials into microparticles including oxides, non-oxides, metals, metalloids, glasses and composites.

In one application, an improved TBC system would allow increasing the inlet temperature of a gas turbine from 1600° C. to 1800° C. thereby resulting in a 10% gross thermal efficiency gain and a 20% core power increase. One embodiment, described herein includes replacing conventional stabilized zirconia outer layer of the TBC system with non-oxide ceramics, thereby increasing the thermal resistance of the turbine blades, and reducing the growth of weak oxide interlayers.

In another application, the spherical agglomerate microparticles may be used to create a coating with increased mechanical properties such as toughness or strength based on the composite nature and nanograin scale of the particles.

It will be clear that the various features of the foregoing systems and/or methodologies may be combined in any way, creating a plurality of combinations from the descriptions presented above.

While various embodiments have been described above, it should be understood that they have been presented by way of example only, and not limitation. Thus, the breadth and scope of an embodiment of the present invention should not be limited by any of the above-described exemplary embodiments but should be defined only in accordance with the following claims and their equivalents.

What is claimed is:

1. A composition comprising: a plurality of microparticles, wherein the microparticles comprise agglomerates of nanopowder, wherein the nanopowder includes a material selected from the group consisting of: a ceramic material, a metal, an alloy, a polymer, and a combination thereof,
wherein the microparticles are characterized by having:
an essentially spherical shape,
nanograin features substantially identical to nanograin features of the nanopowder prior to formation into the microparticles, and
a nanoscale porosity defined by the nanograin features,
wherein the plurality of microparticles have an essentially uniform size relative to one another,
wherein the composition has flowability having a Hausner Ratio representing tapped density:bulk density less than 1.25.

2. The composition as recited in claim 1, wherein an average diameter of the nanograin features is in a range of greater than 0 nanometer and less than 1000 nanometers.

3. The composition as recited in claim 2, wherein the average diameter of the nanograin features is in a range of greater than 0 nanometers and less than about 100 nanometers.

4. The composition as recited in claim 1, wherein the nanopowder is a non-oxide material.

5. The composition as recited in claim 1, wherein the nanopowder is substantially free of oxygen.

6. The composition as recited in claim 1, wherein the composition is a powder.

7. The composition as recited in claim 1, wherein the microparticles are particles having a largest diameter in a range of greater than about 5 microns to less than about 500 microns.

8. The composition as recited in claim 1, wherein the plurality of microparticles have essentially uniform densities relative to one another.

9. The composition as recited in claim 1, wherein the composition has flowability having an Angle of Repose less than 40 degrees.

10. A product comprising a ceramic coating formed of the composition as recited in claim 1, the product comprising:
the ceramic coating comprising the nanograin features and the nanoscale porosity of the microparticles,
wherein the ceramic coating has physical features characteristic of spraying,
wherein the ceramic coating has a crystalline structure that does not include an oxygen component.

11. A powder for fabricating a three-dimensional structure using an additive manufacturing technique, the powder comprising the composition as recited in claim 1.

12. The powder as recited in claim 11, wherein the additive manufacturing technique is selected from the group consisting of: binder jet printing, selective laser melting, and hot pressing.

13. A method comprising:
creating an emulsion having a plurality of spherical droplets by agitating a mixture comprising a suspension and a carrier fluid, wherein the suspension comprises a nanopowder and a solution, wherein the carrier fluid is immiscible with the suspension,
curing the emulsion for causing the plurality of spherical droplets to form a plurality of spherical microparticles; and
collecting the plurality of spherical microparticles.

14. The method as recited in claim 13, wherein the suspension comprises at least one additive selected from the group consisting of: a suspending agent, a curing agent, and an acid.

15. The method as recited in claim 13, wherein the carrier fluid comprises a surfactant.

16. The method as recited in claim 13, comprising controlling the creation of the emulsion to form spherical droplets having average diameters in a pre-defined range.

17. The method as recited in claim 13, wherein diameters of a majority of the spherical microparticles do not vary by greater than 40 percent from a mean average diameter of the plurality of spherical microparticles.

18. The method as recited in claim 13, controlling the curing to cause the spherical microparticles to have average densities in a pre-defined range.

19. The method as recited in claim 13, wherein the nanopowder comprises at least one material selected from the group consisting of: a ceramic nanopowder, a metal nanopowder, an alloy nanopowder, a polymer nanopowder, and a combination thereof.

20. The method as recited in claim 13, wherein the nanopowder has nanograin features and a nanoscale porosity.

21. The method as recited in claim 20, wherein an average diameter of the nanograin features is in a range of greater than 0 nanometer and less than 1000 nanometers.

22. The method as recited in claim 13, wherein the nanopowder is a non-oxide.

23. The method as recited in claim 13, wherein the nanopowder is a metal boride.

24. The method as recited in claim 13, wherein the viscosity of the solution substantially matches the viscosity of the carrier fluid.

25. The method as recited in claim 13, wherein a ratio of the suspension to the carrier fluid is in a range of 1:1 to 1:5, wherein the carrier fluid forms the continuous phase of the emulsion.

26. The method as recited in claim 13, further comprising heating the collected spherical microparticles to a temperature in a range of greater than 200 degrees Celsius to less than 3000 degrees Celsius.
